(19) United States
(12) Patent Application Publication
(10) Pub. No.: US 2009/0148660 A1
(43) Pub. Date: Jun. 11, 2009

(54) INTUMESCENT STRIPS FOR STRUCTURAL BEAM FIRE PROTECTION

(75) Inventors: Mark I. Cooper, Dronfield (GB); Ian G. Stewart, Sawtry (GB); Erik M. W. van Schaijk, Sint Michielsgestel (NL); Neil A. Wheat, Sutton-in-Ashfield (GB)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/033,202

(22) Filed: Feb. 19, 2008

Related U.S. Application Data
(60) Provisional application No. 60/992,828, filed on Dec. 6, 2007.

(51) Int. Cl. B32B 3/10; B32B 27/38; B05D 1/36; B28B 7/36; B32B 3/26

(52) U.S. Cl. 428/137; 428/413; 428/158; 427/258; 264/338

(57) ABSTRACT

An intumescent strip for fire protecting cellular beams is disclosed. The intumescent strips of the present invention are made from flexible intumescent compositions and retain their flexibility after being molded into a solid. The strips are often generally U-shaped to fit over the edge of an opening in a cellular beam. The intumescent strip may be adhered to the beam with an adhesive and the entire beam including the strips may be covered with a thin film intumescent coating.

### CROSS-REFERENCE TO RELATED APPLICATIONS

This application claims the benefit of U.S. Provisional Patent Application Ser. No. 60/992,828, filed Dec. 6, 2007, which is incorporated by reference herein in its entirety.

### FIELD OF THE INVENTION

The present invention relates to intumescent coatings for structural applications.

### BACKGROUND INFORMATION

An intumescent is a substance which reacts and swells as a result of heat exposure, increasing in volume, and decreasing in density. Intumescent coatings are often used in passive fire protection for structural columns and beams and are an industry-accepted method of imparting fire protection to structural steel.

Intumescent coatings function by charring and swelling of the coating on exposure to extreme heat. The expanded char provides an insulating barrier around the steel. The char layer lengthens the time taken for the steel to reach the critical temperature at which it starts to deform. This critical temperature depends on the exact composition (or grade) of the steel, the type of beam and the load bearing capacity of the steel within the specific structure. Accordingly, the critical temperature can vary significantly, e.g., 350° C.-750° C. (660° F.-1380° F.).

Two generic types of intumescent coatings are manufactured for use by the construction industry and can be classified as thin film and thick film coatings. Thin film intumescent coatings are the most commonly used of the two. Thin film intumescent coatings are easy to apply by normal painting techniques and usually provide a surface finish, which is aesthetically pleasing. Thin film intumescent coatings can be solvent or water based and typically have a dry film thickness (dft) of about 0.25-1.0 mm for about 30 minutes fire resistance and up to 2.0-4.0 mm for about 120 minutes fire resistance.

Thick film intumescent coatings are normally epoxy based and, typically, have dft's in the range of about 2.0-4.0 mm for about 30 minutes fire resistance and about 15-20 mm for about 120 minutes fire resistance although longer periods of fire resistance are also possible. Application of thick film intumescent coatings can be either by spray, trowel, brush or casting techniques. Thick film intumescent coatings are very tough and durable and are ideally suited to areas which may be subjected to environmental extremes and mechanical damage, or where access for future inspection and maintenance will be restricted.

Cellular beams and castellated beams are structural steel beams where geometric shapes have been cut from the main web of the beam. This provides a beam with a deeper web while using less material. Additionally, the openings within the web of the beam provide convenient openings for services, like HVAC, piping, and conduit, to pass through the beam. The effect is that the overall building height can be reduced and providing significant height savings per floor.

Concern has been raised that the temperature of the intumescent coated web steel between the openings in a cellular beam, referred to as the web-post, may increase at a faster rate than a similar size web in an intumescent coated solid beam. If the temperature of the web-post increases faster than expected premature failure of the cellular beam could occur due to instability of the web-post. Traditional practice has been to add approximately 20% extra intumescent coating to a cellular beam compared to that which would be necessary to protect a beam without openings of the same section factor.

The traditional practice of adding extra intumescent coating to cellular beams has been found to be flawed. As mentioned above, intumescent coatings char and swell when exposed to extreme heat. Charring can cause linear shrinkage of the intumescent coating around the openings causing the coating to pull away from the opening and leading to exposure of the metal, accelerated heating and premature failure of the beam. This occurrence is particularly common around web opening edges when thin film intumescent coatings are used.

This shortcoming of thin film intumescent coatings for cellular beams is in part due to the difficulty of properly applying the correct amount of coating around the web opening edges. Also a problem is that the coating around the edges may be damaged during installation of the utilities through the web openings. Thirdly utilities passing through the openings may restrict intumescent expansion. All modes cause, insufficient insulation during extreme heat conditions due to incomplete intumescent char formation and exposure of the web steel leading to premature failure of the beam.

The present invention has been developed in view of the foregoing.

### SUMMARY OF THE INVENTION

The present invention provides an intumescent strip for fire protecting cellular beams. The intumescent strips of the present invention are made from flexible intumescent compositions and retain their flexibility after being molded into a solid. The strips are often generally U-shaped to fit over the edge of an opening in a cellular beam. The intumescent strip may be adhered to the beam with an adhesive and the entire beam including the strips may be covered with a thin film intumescent coating.

One aspect of the present invention provides a solid intumescent section comprising a strip having a generally U-shaped cross-section, wherein the strip comprises a molded, epoxy-containing flexible intumescent composition.

Another aspect of the present invention provides a cellular beam comprising a metallic substrate, an opening passing through the substrate defined by at least one edge, an intumescent strip covering at least a portion of the at least one edge and an intumescent coating covering the cellular beam.

Yet another aspect of the present invention provides a method of providing passive fire protection for a structural beam comprising the steps of providing a structural beam having at least one opening defined by at least one edge, covering the at least a portion of the at least one edge with a molded intumescent strip and coating the structural beam with an intumescent coating.

A further aspect of the present invention provides a method of making a solid intumescent strip comprising the steps of providing a liquid intumescent coating composition, and molding the composition into a solid, elongated U-shaped strip.

These and other aspects will become more apparent from the following description.

### BRIEF DESCRIPTION OF THE DRAWINGS

FIG. 1 is an oblique view of a cellular beam fitted with intumescent strips according to one embodiment of the present invention.

FIG. 2 is a cross-sectional view of the cellular beam of FIG. 1 along section line E-E according to one embodiment of the present invention.

FIG. 3 a top and front view of an intumescent strip according to one embodiment of the present invention.

FIG. 4 is a front view of an intumescent strip according to one embodiment of the present invention.

FIG. 5 is a side view of an intumescent strip according to one embodiment of the present invention.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As used herein, the term “intumescent coating” refers to a coating which swells as a result of heat exposure, thus increasing in volume, and decreasing in density to form an insulative char that can be used for passive fire protection of structural elements of a building. As used herein the term “beam” refers to a metal structural element of building construction, including but not limited to I-beams, C-channels, hollow structural sections, pipe and angle. As used herein, “cellular beam” refers to any beam having at least one opening passing through the beam in a direction generally perpendicular to a longitudinal direction of the beam. These openings can have various shapes including, but not exclusively, circle, square, hexagonal, rectangle and oval. As used herein, the term “flexible intumescent composition” refers to an intumescent composition that is capable of bending.

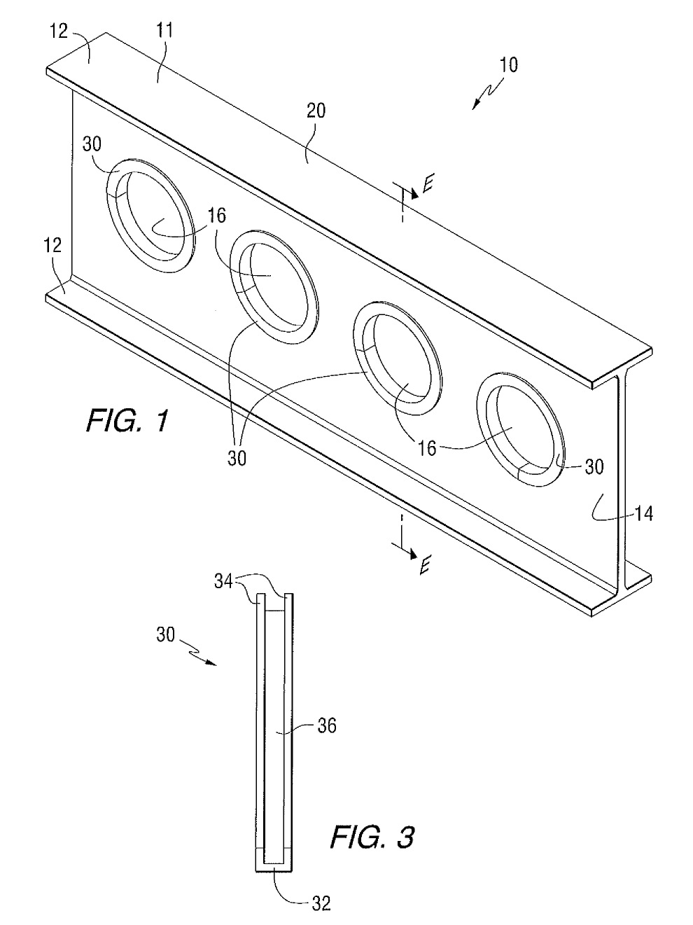

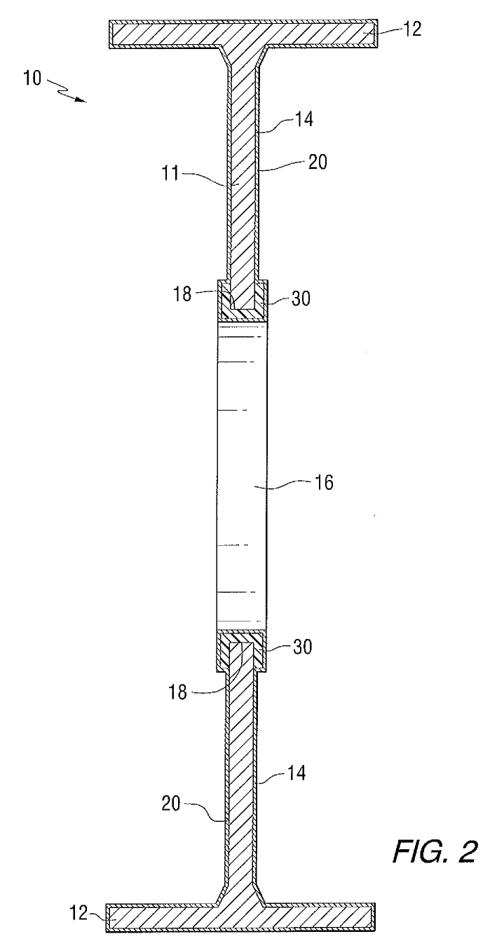

Referring now to FIGS. 1 and 2, a cellular beam with intumescent strips and intumescent coating is shown. FIG. 2 represents a cross-section of the cellular beam shown in FIG. 1 along section line E-E. The cellular beam 10 shown in FIGS. 1 and 2 is a steel I-beam 11. The I-beam comprises two horizontal flanges 12 and a vertical web 14. Openings 16 within the web provide access for utilities such as duct work to pass through the web 14 of the cellular beam 10. The openings 16 of the I-beam 11 are covered with or coped with intumescent strips 30. The intumescent strips 30 may be adhered to the opening edges 18 and web 14 by using a high temperature resistant epoxy adhesive component or by using a liquid intumescent composition described below. Once the intumescent strips 30 have been installed around the openings 16, the cellular beam is coated with a thin film intumescent coating 20.

The intumescent strips 30 may be molded from a flexible liquid intumescent composition which has:

(a) a polyepoxide resin,

(b) a curing agent adapted to cure the polyepoxide resin,

(c) an additive component comprising a mixture of materials adapted to provide a source of (i) zinc, (ii) boron, (iii) phosphorus and (iv) an expansion gas upon thermal decomposition. The flexible intumescent is based upon polyepoxide and curing agent resins of reduced viscosity that when pigmented provide a finished composition with a final viscosity that allows for easier workability and molding.

Flexible intumescent coatings of the composition described above are described in U.S. Pat. No. 5,070,119 which is a divisional application of U.S. Pat. No. 5,108,832 to Nugent, Jr. et al., both of which are herein incorporated by reference.

The intumescent strips 30 may be made by molding the liquid flexible intumescent coating composition in a mold and then allowing the composition to cure until the liquid material is solidified. The solidified material is then released from the mold.

As mentioned above, the cellular beam 10 is coated with a thin film intumescent coating 20. Before application of the intumescent strips the cellular beam is in some cases blast-cleaned followed by application of a primer. Suitable primers may include, but are not limited to, epoxy primers containing zinc dust or other anti-corrosion pigments, alkyd or zinc silicate. After application of the primer, the intumescent strips are adhered to the primer. The intumescent strips are in some cases adhered to the opening edges 18 and web 14 by using a high temperature resistant epoxy adhesive component or by using a liquid intumescent composition. Finally, the entire beam 11 is coated with a thin film intumescent coating.

Typically the thin film intumescent coatings can contain either organic solvent or water being referred to as solvent-borne or water-borne respectively. Solvent-borne, thin film intumescent coatings often comprise an acrylic and/or acrylate resin. Water-borne, thin film intumescent coatings often comprise a vinyl copolymer dispersion resin. Additional components may be added to the resins of each thin film intumescent coating as a mixture of materials to provide a source of (i) phosphorous, (ii) carbon, and (iii) expansion gases upon thermal decomposition. For example, particularly effective solvent-borne or water-borne thin film intumescent coatings are available from PPG Industries and identified by the trademark STEELGUARD.

Although the primer described above could be illustrated in FIG. 2 as a layer between the beam 11 and the thin film intumescent coating 20 for clarity the primer is not shown in FIG. 2. Similarly, the adhesive described above could be illustrated in FIG. 2 as a layer between the intumescent strips 30 and the beam 11.

Referring now to FIGS. 3-5. An intumescent strip according to one embodiment of the present invention is shown. FIG. 3 shows a top and partial front view of an intumescent strip. The intumescent strips 30 are often U-shaped strips or channels having a cross-member 32 and opposing legs 34. The interior surfaces of cross-member 32 and legs 34 form channel 36. This U-shape configuration allows the intumescent strips 30 to be easily and effectively applied to the opening edge 18 of cellular beam 10. The cross-member 32 has an exterior face 38 located opposite the channel 36.

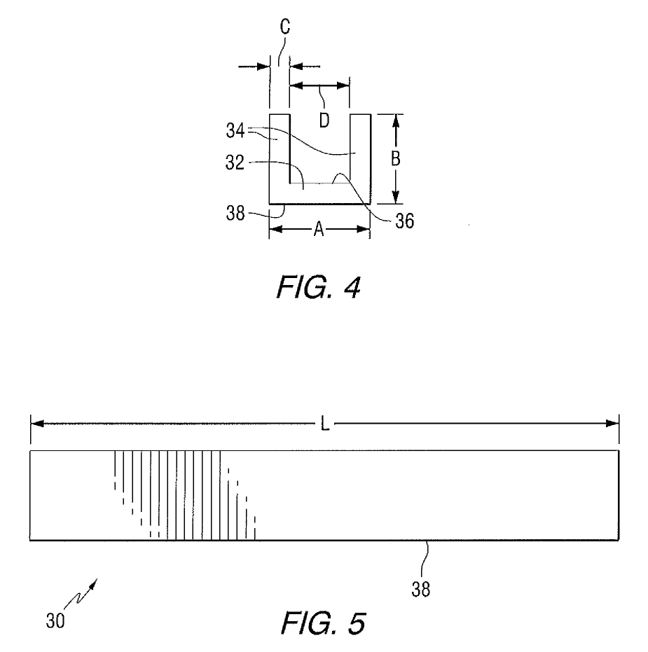

The exterior face has a width, shown as A in FIG. 4 of, for example, about 5 mm to about 100 mm. For example, about 10 mm to about 30 mm, for example about 14 mm to about 18 mm. The legs 34 of the intumescent strips 30 have a depth B, which in some cases may corresponds to the dimension A of the exterior face 38. Each leg 34 and the face 32 also have a thickness shown as C in FIG. 4. The thickness C may be from, for example, about 2 mm to about 10 mm, for example, about 4 mm to about 6 mm, for example about 5 mm. The dimension D shown in FIG. 4 indicates the width of the channel 36. Dimension D is largely determined by the thickness of the opening edge 18 of the cellular beam 10.

The ability to mold the intumescent strips 30 to a pre-determined thickness specification allows the expansion of the intumescent upon exposure to extreme heat to be carefully controlled. This is particularly important around openings 16 in the cellular beam 10 due to limited clearances between the opening 16 and the services passing there through. Thin film intumescent coatings normally in a fire expand 40-50 times their applied coating thickness, Often the gap between opening 16 and the services is not large enough to allow this expansion, if, in fact, the expansion did occur properly at the edges. The epoxy intumescent composition from which the strips are molded only expand to approximately 4 times their original thickness when exposed to extreme heat and still maintain the required level of insulation. Therefore, the properly secured and dimensioned intumescent strips 30 allow expansion to be carefully controlled in this gap and kept at a much lower level that is not obstructed by the services passing there through.

As seen in FIG. 5, the intumescent strip also has a length L. L may be, for example, about 0.3 meter to about 3 meters, for example, about 0.6 meter to about 2 meters. In an exemplary embodiment, L may be about 1.0 meter to about 1.6 meters.

The intumescent strips 30 of the present invention also provide a much tougher and more impact-resistant surface than the traditional intumescent coatings. Accordingly, they are less susceptible to mechanical damage which may occur during installation of the beams and installation of the associated services through the openings of the beams.

While the aim of intumescent coatings is to insulate a beam from extreme heat during a fire, the insulation must be uniform. This is particularly important in cellular beams where weakening of web posts can quickly lead to beam failure by web post buckling. The ideal intumescent insulates and maintains a constant temperature across the web post and flanges. A ratio of 1:1 for web post to lower-flange steel temperature is desired. To date, this has not been achieved with current thin film intumescent practices. This is largely due to reduced and/or non-uniform intumescent char thickness and/or shrinkage of the thin film intumescent coating around the edge of an opening within a cellular beam. Indicative fire tests have shown that after intumescing, the intumescent strips 30 of the present invention remained around the openings provided uniform intumescent char thickness and provided the temperature data to give a web post to lower flange temperature ratio nearer to 1:1. This test was performed with intumescent strips 30 covered with various thicknesses ranging from 0.2 mm to 4 mm of STEELGUARD thin film intumescent coatings provided by PPG Industries. The thicknesses chosen related to the standard thickness used on the non-cellular “parent” I-beams.

In one embodiment of the present invention a beam 11 is coated with a primer then a thick film intumescent coating may be brushed on around the edges 18 of a cellular beam 10. The thick film can be built up with a brush to a desired thickness in the edge 18 area although this process is more time-consuming and less controllable than other embodiments. Once the thick film intumescent has been applied, the entire beam 11 is may coated with a thin film intumescent as described above.

Use of the intumescent strips of the present invention has many advantages over the traditional means of coating cellular beams. These advantages include a tougher and more impact-resistant opening edge of the cellular beam; more controlled expansion of the intumescent coating when subjected to extreme heat; less reliance on spray application and/or stripe coating methods to provide uniform coating thickness around the opening edges; and the intumescent strips reduce the need to add additional intumescent coating to cellular beams compared to the non-cellular parent beam.

Whereas particular embodiments of this invention have been described above for purposes of illustration, it will be evident to those skilled in the art that numerous variations of the details of the present invention may be made without departing from the invention as defined in the appended claims.

1. A solid intumescent section comprising:
a strip having a generally U-shaped cross-section;
wherein the strip comprises a molded, epoxy-containing flexible intumescent composition.

2. The solid intumescent section of claim 1, wherein the intumescent composition comprises:
a polyepoxide resin,
a curing agent adapted to cure the polyepoxide resin, and
an additive component comprising a mixture of materials adapted to provide a source of zinc, boron, phosphorus and an expansion gas upon thermal decomposition.

3. The solid intumescent section of claim 1, wherein the U-shaped cross-section defines an interior channel structured and arranged to cover the edge of a web opening in a structural cellular beam.

4. The solid intumescent section of claim 3, wherein the interior channel has a width of between about 4 mm and about 50 mm.

5. The solid intumescent section of claim 1, wherein the U-shaped cross-section comprises a cross-member and two leg sections, wherein the cross-member and two leg sections each have a thickness of between about 4 mm to about 6 mm.

6. The solid intumescent section of claim 5, wherein the depth of the leg members is about 14 mm to about 18 mm.

7. A cellular beam comprising:
a metallic substrate;
an opening passing through the substrate defined by at least one edge;
an intumescent strip covering at least a portion of the at least one edge; and
an intumescent coating covering at least a portion of the cellular beam.

8. The cellular beam of claim 7, further comprising a primer deposited on at least a portion of the metallic substrate.

9. The cellular beam of claim 7, wherein the intumescent strip comprises:
a polyepoxide resin,
a curing agent adapted to cure the polyepoxide resin, and
an additive component comprising a mixture of materials adapted to provide a source of zinc, boron, phosphorus and an expansion gas upon thermal decomposition.

10. The cellular beam of claim 7, wherein the intumescent coating is formed from a solvent-borne composition comprising an acrylic and/or acrylate resin or a water-borne composition comprising a vinyl copolymer dispersion resin,
wherein the composition further comprises a mixture of materials to provide a source of (i) phosphorous, (ii) carbon, and (iii) expansion gases upon thermal decomposition.

11. The cellular beam of claim 7, wherein the metal substrate is an I-beam comprising two flanges and a web connecting the two flanges.

12. The cellular beam of claim 11, wherein the opening passes through the web of the I-beam.

13. The cellular beam of claim 7, further comprising an adhesive securing the intumescent strip to the at least one edge.

14. The cellular beam of claim 13, wherein the adhesive comprises a two component high temperature resistant epoxy adhesive or liquid material with a composition comprising a polyepoxide resin, a curing agent adapted to cure the polyepoxide resin, and an additive component comprising a mixture of materials adapted to provide a source of zinc, boron, phosphorus and an expansion gas upon thermal decomposition.

15. A method of providing passive fire protection for a structural beam comprising the steps of:
providing a structural beam having at least one opening defined by at least one edge;
covering at least a portion of the at least one edge with a first intumescent coating comprising i) a molded intumescent strip adhered to the at least one edge, or ii) a thick film intumescent coating; and
coating at least a portion of the structural beam and first intumescent coating with a second intumescent coating.

16. The method of claim 15, wherein the second intumescent coating is a thin film intumescent coating.

17. The method of claim 15, further comprising the step of covering at least a portion of the structural beam with a primer before covering at least a portion of the at least one edge with a first intumescent coating.

18. A method of making a solid intumescent strip comprising the steps of:
providing a liquid intumescent coating composition;
molding the composition into a solid, elongated U-shaped strip.
